(19) United States
(12) Patent Application Publication
(10) Pub. No.: US 2018/0354517 A1
(43) Pub. Date: Dec. 13, 2018

(54) DRIVING ASSISTANCE APPARATUS

(71) Applicant: DENSO CORPORATION, Kariya-city, Aichi-pref. (JP)

(72) Inventors: Hiroto BANNO, Kariya-city, Aichi-pref. (JP); Sei IGUCHI, Kariya-city, Aichi-pref. (JP)

(21) Appl. No.: 15/778,421

(22) PCT Filed: Sep. 13, 2016
(86) PCT No.: PCT/JP2016/076885

§ 371 Date: May 23, 2018

(30) Foreign Application Priority Data
Nov. 30, 2015 (JP) 2015-232879

(51) Int. Cl. B60W 30/18; B60W 50/10; B60W 50/14; B60W 50/12; G06K 9/00

(52) U.S. Cl. CPC B60W 30/18163; B60W 50/10; B60W 50/14; B60W 2540/00; G06K 9/00845; B60W 2420/42; B60W 50/12

(57) ABSTRACT

A driving assistance apparatus includes an operation determiner section and a change approver section. The operation determiner section determines whether a driver of a vehicle executes a safety confirming operation against lane change based on information from a sensor used to detect a state of a driver. The change approver section approves an automated lane change by a lane changer section. Herein, the change approver section disapproves an automated lane change by the lane changer section when the operation determiner section determines that the driver fails to execute a safety confirming operation against lane change.

### CROSS REFERENCE TO RELATED APPLICATION

The present application is based on Japanese Patent Application No. 2015-232879 filed on Nov. 30, 2015, the disclosure of which is incorporated herein by reference.

### TECHNICAL FIELD

The present disclosure relates to a driving assistance apparatus which assists driving of a driver.

### BACKGROUND ART

There is conventionally known a technology which assists driving of a driver. For instance, Patent literature 1 discloses a technology that performs an automated lane change of a vehicle to an adjacent lane based on a manipulation to a blinker lever by a driver.

### PRIOR ART LITERATURES

### Patent Literature

Patent literature 1: JP 2005-519807 A (US 2005/0155808 A1)

### SUMMARY OF INVENTION

However, the technology disclosed in Patent literature 1 performs an automated lane change of the vehicle to an adjacent lane based on the driver's manipulation to a blinker lever; thus, the lane change is performed without need of the driver's confirming a safe condition.

Suppose a case where a subject vehicle is automatically moved to change to an adjacent lane. Such a case may suppose that an autonomous sensor of the subject vehicle is used to monitor a rear-lateral vehicle that is running an adjacent lane and in a rear and lateral area relative to the subject vehicle, and a lane change of the subject vehicle is thereby performed automatically while the system of the subject vehicle secures a safe condition in the rear and lateral area. However, the present situation has limits in the technology such as a limit of a detection range of the autonomous sensor; thus, the overestimation of the system of the vehicle is undesirable. It is thus desirable that the driver executes a safety confirmation.

It is an object of the present disclosure to provide a driving assistance apparatus capable of prompting a driver to execute a safety confirmation.

To achieve the above object, according to an aspect of the present disclosure, a driving assistance apparatus is provided with a lane changer section used in a vehicle to perform an automated lane change of the vehicle. The driving assistance apparatus includes an operation determiner section and a change approver section. The operation determiner section is configured to determine whether a driver of the vehicle executes a safety confirming operation at a lane change based on information from a sensor used to detect a state of the driver. The change approver section is configured to approve an automated lane change by the lane changer section. Herein, the change approver section disapproves an automated lane change by the lane changer section when the operation determiner section determines that the driver fails to execute a safety confirming operation at a lane change.

According to the above configuration, when the operation determiner section determines that the driver does not execute a safety confirming operation at a lane change, the change approver section does not approve an automated lane change by the lane changer section. This prevents an automated lane change of the vehicle unless the driver executes a safety confirming operation at a lane change. The driver thereby becomes accustomed to executing a safety confirming operation at a lane change even in a case where the vehicle is controlled to perform an automated lane change.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an example of a schematic configuration of a driving assistance system;

FIG. 2 is a diagram illustrating an example of a schematic configuration of a driving assistance ECU;

FIG. 3 is a flowchart illustrating an example of a sequence of an LCA related process by a driving assistance ECU;

FIG. 4 is a schematic diagram for explaining an example of a state change of an LCA function part;

FIG. 5 is a diagram for explaining an effect according to a configuration in a first embodiment; and

FIG. 6 is a diagram illustrating an example of a schematic configuration of a driving assistance ECU according to a second embodiment.

### EMBODIMENTS FOR CARRYING OUT INVENTION

A plurality of embodiments and modification examples for disclosure are explained with reference to the drawings. To simplify the explanation, among the embodiments and modification examples, a second component having the same function as that of a first component illustrated in a drawing in the foregoing explanation is assigned with the same reference sign of the first component and may be omitted from the following explanation. The second component assigned with the same reference sign may refer to the explanation in foregoing embodiments and/or modification examples.

### First Embodiment

<Schematic Configuration of Driving Assistance System 1>

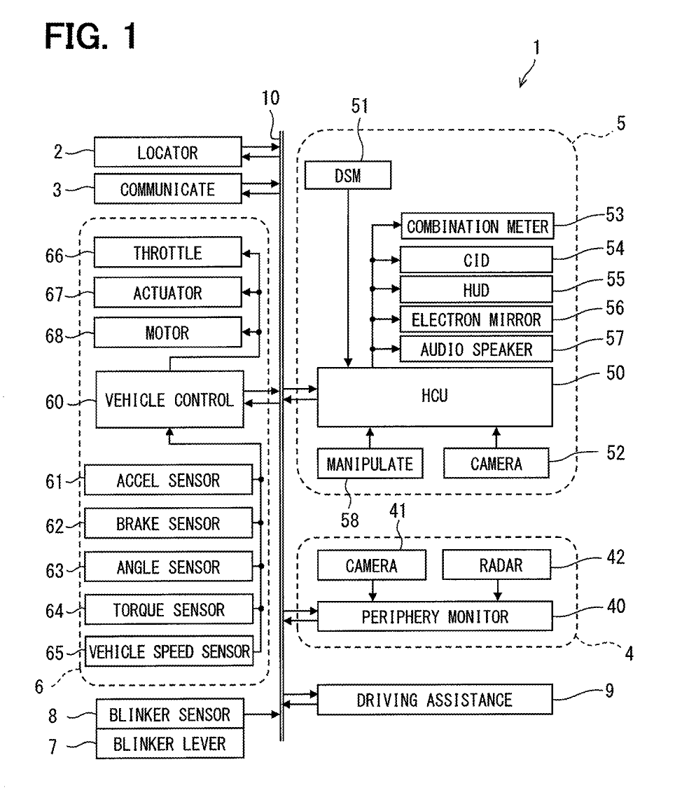

The following explains a first embodiment of the present disclosure with reference to the drawings. FIG. 1 illustrates a driving assistance system 1 mounted in a vehicle. The driving assistance system 1 includes an ADAS (Advanced Driver Assistance Systems) locator 2, an ITS (Intelligent Transport Systems) communicator 3, a periphery monitoring system 4, an HMI (Human Machine Interface) system 5, a vehicle control system 6, a blinker lever 7, a blinker switch 8, and a driving assistance ECU 9. The ADAS locator 2, the ITS communicator 3, the periphery monitoring system 4, the HMI system 5, the vehicle control system 6, the blinker switch 8, and the driving assistance ECU 9 are connected via an in-vehicle LAN 10, for instance, to exchange the information with each other by communication. The vehicle mounted with the driving assistance system 1 is referred to as a host vehicle or a subject vehicle.

The ADAS locator 2 includes (i) a GNSS receiver, (ii) inertia sensors such as a 3D gyro sensor, and (iii) a memory which stores a map data. The GNSS (Global Navigation Satellite System) receiver receives positioning signals from a plurality of artificial satellites. The 3D gyro sensor includes a three axis gyro sensor and a three axis acceleration sensor.

The ADAS locator 2 measures a position of the host vehicle by combining positioning signals received by the GNSS receiver and measurement results of the inertia sensors. The ADAS locator 2 reads out the map data of an area ahead of the host vehicle from the memory, and extracts the road information such as a road shape, the number of lanes, a lane width, a lane regulation information, a speed regulation value, an intersection position. The ADAS locator 2 then outputs the position information on the host vehicle and the road information ahead of the host vehicle to the in-vehicle LAN 10. Note that “information,” which may be used not only as an uncountable noun but also a countable noun, is equivalent to an informational item. One information is equivalent to one informational item; a plurality of informations are equivalent to a plurality of informational items.

Note that another configuration may be provided which acquires the road information by using an in-vehicle communication module used for a telematics communication such as a DCM (Data Communication Module) mounted in the host vehicle.

The ITS communicator 3 performs a wireless communication with an in-vehicle communicator mounted in a peripheral vehicle around the host vehicle and/or a roadside unit installed in a roadside. The ITS communicator 3 acquires the information such as the position information and the travel speed information of a peripheral vehicle around the host vehicle, via a vehicle-to-vehicle communication by a in-vehicle communicator or a road-to-vehicle communication by a roadside unit. The ITS communicator 3 outputs the acquired information to the in-vehicle LAN 10.

The periphery monitoring system 4 includes a periphery monitoring camera 41; a periphery monitoring sensor such as a milliwave radar 42; and a periphery monitoring ECU 40. The periphery monitoring system 4 may be configured to include a periphery monitoring sensor such as a sonar and LIDAR (Light Detection and Ranging/Laser Imaging Detection and Ranging). The periphery monitoring system 4 detects an obstacle such as a mobile object and a static object. The mobile object includes a pedestrian, an animal other than a human being, a bicycle, a motorcycle, or a different vehicle; a static object includes a falling object on a road, a guardrail, a curbstone, or a tree. The periphery monitoring system 4 further detects a lane dividing marking line, a color of a traffic light, a traffic sign painted on a road, and an indication of a road sign.

The HMI system 5 includes several display devices such as a combination meter 53, a CID (Center Information Display) 54, an HUD (Head-Up Display) apparatus 55, and an electron mirror 56. The HMI system 5 further includes a DSM (Driver Status Monitor) 51, a rear and lateral camera 52, an audio speaker 57, and a manipulation device 58. The HMI system 5 receives an input manipulation from the driver of the host vehicle, presents the information to the driver of the host vehicle, or monitors the state of the driver of the host vehicle.

The vehicle control system 6 includes (i) detection sensors that each detect a driving manipulation, such as an accelerator position sensor 61, a brake stepping-on force sensor 62, a steering angle sensor 63, and a steering torque sensor 64; and (ii) a vehicle speed sensor 65 that detects a travel state of the host vehicle. The vehicle control system 6 further includes (i) a travel control device such as an electronically controlled throttle 66, a brake actuator 67, and an EPS (Electric Power Steering) motor 68; and (ii) a vehicle control ECU 60. The vehicle control system 6 controls the travel of the host vehicle based on the driving manipulation by the driver, instructions from the driving assistance ECU 9.

The blinker lever 7 is a manipulation member to perform a lighting manipulation of a turn indicator of the host vehicle. In the first embodiment, this blinker lever 7 is equivalent to a predetermined manipulation member. The blinker switch 8 is a switch to detect a left or right lighting manipulation to the blinker lever 7. The blinker switch 8 outputs a blinker signal at the time of turning to the right or left to the in-vehicle LAN 10 depending on manipulation to the blinker lever 7.

The driving assistance ECU 9, which includes a CPU, a volatile memory, a nonvolatile memory, an I/O, and a bus that connects the foregoing, executes various processes by executing control programs stored in the nonvolatile memory. The driving assistance ECU 9 is equivalent to a driving assistance apparatus. All or part of the functions executed by the driving assistance ECU 9 may be configured as hardware circuits such as one or more ICs.

The driving assistance ECU 9 controls the vehicle control ECU 60, thereby executing a plurality of driving assistance applications which perform assistance or vicarious execution of driving manipulation by the driver. The driving assistance ECU 9 will be explained in detail later.

<Schematic Configuration of Peripheral Monitoring System 4>

The following explains a schematic configuration of the periphery monitoring system 4. The periphery monitoring system 4 includes a periphery monitoring ECU 40, a periphery monitoring camera 41, and a milliwave radar 42.

The periphery monitoring camera 41 is a camera with a single lens or plural lenses, capturing images of the periphery of the host vehicle successively. The following explains, as an example, a configuration where the periphery monitoring camera 41 includes a front camera. Note that another configuration may be provided where the periphery monitoring camera 41 includes a camera capturing images of other areas other than a front area, such as a rear camera having a capture range of a predetermined range rearward of the host vehicle.

The periphery monitoring camera 41, which turns the optical axis to a road surface ahead of the host vehicle, is installed in a room mirror of the host vehicle, for instance. The peripheral monitoring camera 41 captures an image of a range of about 80 meters from the host vehicle with a horizontal viewing angle of about 45 degrees. The peripheral monitoring camera 41 captures images successively and outputs the data of the capture images successively to the periphery monitoring ECU 40.

The milliwave radar 42 sends out the millimeter wave or the submillimeter wave around the host vehicle successively, and receives the reflected wave reflected by an obstacle successively. The following explains, as an example, a configuration where the milliwave radar 42 includes a rear and right milliwave radar having a sensing range from a rear and right area to a rear area relative to the host vehicle, and a rear and left milliwave radar having a sensing range from a rear and left area to a rear area relative to the host vehicle. Note that another configuration may be provided where the milliwave radar 42 includes another milliwave radar 42 having a different sensing range such as a front milliwave radar 42 having a sensing range of a front area relative to the host vehicle.

For instance, the rear and right milliwave radar, which is installed on a right side of the rear part of the host vehicle, emits the submillimeter wave of 24 GHz band to a range with a horizontal scanning angle of about 120 degrees from a rear area to a rear and right area relative to the host vehicle, receiving the reflected wave. The left rear milliwave radar is the same as the rear and right milliwave radar except for right and left reversed. The maximum detection distance of the milliwave radar 42 is about 70 to 150 meters. The milliwave radar 42 outputs a scanning result based on the received signal to the periphery monitoring ECU 40 successively.

The periphery monitoring ECU 40, which includes a CPU, a volatile memory, a nonvolatile memory, an I/O, and a bus that connects the foregoing, executes various processes by executing control programs stored in the nonvolatile memory. All or part of the functions executed by the periphery monitoring ECU 40 may be configured as hardware components such as one or more ICs.

The periphery monitoring ECU 40, which acquires the data of capture image from the periphery monitoring camera 41, detects data with respect to an object present in a front area relative to the host vehicle based on the acquired data; the detected data include a distance from the host vehicle, a relative position with the host vehicle, and a relative speed with the host vehicle. For instance, a known image recognition process such as a template matching may be used to detect as a detection target an object including a pedestrian or a vehicle such as an automobile, a bicycle, a motorcycle.

Note that when a camera with a single lens is used, a relative position of an object with the host vehicle and a distance between an object and the host vehicle may be determined from (i) an installed position and a direction of an optical axis of the periphery monitoring camera 41 relative to the host vehicle and (ii) a position of the object in the capture image. When a camera wish plural lenses, the distance between the host vehicle and the object may be determined based on the parallax amount of a pair of camera lenses. Furthermore, a relative speed of the object with the host vehicle may be determined from a change rate of the distance between the host vehicle and the object. When the detected object is a vehicle the position of which is a front area relative to the host vehicle, it may be regarded as a preceding vehicle, for example.

The periphery monitoring ECU 40 detects lane dividing marking lines in the heading direction of the host vehicle, and the positions of the lane dividing marking lines relative to the host vehicle, from the data of the capture image acquired from the periphery monitoring camera 41. The lane dividing marking line may be detected with a well-known image recognition process such as an edge detection. The position of the lane dividing marking line relative to the host vehicle may be detected from (i) the installed position and the direction of the optical axis of the periphery monitoring camera 41 relative to the host vehicle and (ii) the position of the object in the capture image. Further, the periphery monitoring ECU 40 may detect objects such as a signboard indicating lane regulation, an on-road installation object indicating lane regulation, by using an image recognition process.

Further, the periphery monitoring ECU 40, which acquires the information from the milliwave radar 42, detects data with respect to an object present in a rear and lateral area relative to the host vehicle based on the acquired information; the detected data include a distance from the host vehicle, a relative position with the host vehicle, and a relative speed with the host vehicle.

The periphery monitoring ECU 40 detects an object based on the reception intensity of the reflected waves which are produced by the object reflecting the submillimeter waves transmitted from the milliwave radar 42. Furthermore, the periphery monitoring ECU 40 detects the distance between the host vehicle and the object from a period of time from when transmitting the submillimeter waves to when receiving the reflected waves. In addition, the periphery monitoring ECU 40 detects the direction of the object with the host vehicle from the direction from which the submillimeter waves that produce the reflection waves are sent out, further detecting the relative position of the object to the host vehicle from the distance between the host vehicle and the object, and the direction of the object relative to the host vehicle.

In addition, the periphery monitoring ECU 40 detects the relative speed of the object with the host vehicle with a known technology, based on the Doppler shift between the reflected waves and the submillimeter waves sent out. Further, the relative speed of the object with the host vehicle may be detected from the time-based change rate of the distance between the host vehicle and the object. The periphery monitoring ECU 40 outputs various kinds of detected information to the in-vehicle LAN 10 as monitoring information.

Further, the periphery monitoring ECU 40 may detect the presence of a peripheral vehicle, and the distance, the position, and the speed of the peripheral vehicle relative to the host vehicle, by using the position information and the travel speed information of the peripheral vehicle, which are acquired from the ITS communicator 3.

In addition, with respect to the periphery monitoring system 4, the number of periphery monitoring sensors, the kind, or the combination of kinds are not limited to the examples described in the first embodiment. Another configuration may be provided where a plurality of kinds of periphery monitoring sensors have overlapped sensing ranges; for instance, sensing a front area relative to the host vehicle may be made by a camera and a milliwave radar that are used together. Yet another configuration may be provided where a monitoring sensor may include a milliwave radar having a sensing range covering a diagonally forward left area and a diagonally forward right area relative to the host vehicle, or where a monitoring sensor may include sonars having sensing ranges covering areas adjacent to right and left front corners of the host vehicle, and areas adjacent to right and left rear corners of the host vehicle.

<Schematic Configuration of HMI System 5>

The following explains a schematic configuration of the HMI system 5. The HMI system 5 includes an HCU (Human Machine Interface Control Unit) 50, a DSM 51, a rear and lateral camera 52, a combination meter 53, a CID 54, an HUD apparatus 55, an electron mirror 56, an audio speaker 57, and a manipulation device 58.

The DSM 51 includes (i) a near-infrared light source and a near-infrared camera, and (ii) a control unit that controls the foregoing. The DSM 51 is arranged, for instance, at an upper surface of the instrument panel while having the posture which turns the near-infrared camera towards the driver seat of the host vehicle. The DSM 51 captures an image of the head of the driver who is irradiated with the near-infrared light from the near-infrared light source, by using the near-infrared camera. The capture image by the near-infrared camera is subjected to an image analysis by a control unit. The control unit detects the direction of the driver's face and the sight line direction of both eyes, for instance, from the capture image. This DSM 51 is equivalent to a sensor.

As an example, the DSM 51 detects body parts such as the outline of the face, the eyes, the nose, and the mouth by an image recognition process from the capture image of the face of the driver with the near-infrared camera. The direction of the face of the driver is thus detected from the relative position relation of the respective body parts. In addition, the DSM 51 detects the pupil and corneal reflex of the driver by an image recognition process from the capture image of the face of the driver with the near-infrared camera, detecting the direction of the sight line from the position relation between the pupil and corneal reflex. The DSM 51 outputs the information on the detected face direction and sight line of the driver to the in-vehicle LAN 10.

Further, the DSM 51 may be configured to detect the face direction of the driver by using the distance variation arising due to the face direction in the distance between (i) the face or shoulder and (ii) the driver seat or the headrest. As an example, the DSM 51 may be configured to detect the face direction of the driver from the variation in the distance to the face or shoulder, which is detected by a plurality of distance sensors installed in the driver seat or headrest.

The rear and lateral camera 52, which may be a camera with a single lens, capture image, captures an image of a rear and lateral area relative to the host vehicle successively. The rear and lateral camera 52, which is installed in each of door mirrors on the right and left sides of the host vehicle, captures an image of a predetermined range of a rear and right area relative to the host vehicle. The rear and lateral camera 52 captures images successively and outputs the data of the capture images successively to the HCU 50.

The combination meter 53 is arranged in front the driver seat in the occupant compartment of the host vehicle. The CID 54 is arranged above a center cluster in the occupant compartment of the host vehicle. The combination meter 53 and the CID 54 each display the various images for the information notice on a display screen based on the image data obtained from the HCU 50.

The HUD apparatus 55 projects a display picture, which is formed in the display element based on the image data acquired from HCU 50, onto the windshield of the host vehicle, thereby displaying a virtual image of the display picture to be visually recognized in superimposition onto a front external scenery from the occupant compartment of the host vehicle. The HUD apparatus 55 presents the information to the driver by using a display object displayed as the virtual image.

The electron mirror 56 is a display device displaying successively a capture image of a rear and lateral area relative to the host vehicle with the rear and lateral camera 52. The electron mirror 56 includes a display device displaying a capture image of a rear and right area relative to the host vehicle, and a display device displaying a capture image of a rear and left area relative to the host vehicle. As an example, the electron mirror 56 is installed in a basis of a pillar located in each of both sides of the windshield in the occupant compartment of the host vehicle. The electron mirror 56 acquires capture images captured successively by the rear and lateral camera 52, via the HCU 50, displaying them.

The electron mirror 56 may perform a superimposition display of a display object generated by the HCU 50, in addition to the capture image of the rear and lateral area, which is captured by the rear and lateral camera 52. In addition, the display object generated by the HCU 50 and the capture image of the rear and lateral area captured by the rear and lateral camera 52 may be displayed separately in the respective display regions. The electron mirror 56 presents the information to the driver by using the display object displayed in addition to the capture image of the rear and lateral area relative to the host vehicle.

The audio speaker 57, which is installed, e.g., within the lining of a door of the host vehicle, reproduces a sound or a speech to be able to be heard by the driver of the host vehicle. In detail, the audio speaker 57 outputs a synthesized sound such as a mechanical beep sound or a message. The audio speaker 57 can thus present the information to the driver by using the reproduced sound or speech.

The manipulation device 58 includes switches that the driver of the host vehicle manipulates. For example, the manipulation device 58 includes a steering switch provided in a spoke part of the steering wheel of the host vehicle. The steering switch is used in order that the driver performs the various setups including a setup of whether to activate a driving assistance application, or in order that the driver perform an approval for an automated lane change.

The HCU 50, which includes a CPU, a volatile memory, a nonvolatile memory, an I/O, and a bus that connects the foregoing, implements various processes by executing control programs stored in the nonvolatile memory. All or part of the functions implemented by the HCU 50 may be configured as hardware components such as one or more ICs,

The HCU 50 controls the combination meter 53, the CID 54, the HUD apparatus 55, the electron mirror 56, and the audio speaker 57 to present the information, thereby performing a notice to the driver. In addition, the HCU 30 acquires successively the capture image data of the rear and lateral area relative to the host vehicle from the rear and lateral camera 52, outputting successively the acquired capture image data to the electron mirror 56. Further, the HCU 50 outputs a signal according to a detection result by the DSM 51 or a switch manipulation via the manipulation device 58, to the in-vehicle LAN 10.

<Schematic Configuration of Vehicle Control System 6>

The following explains a schematic configuration of the vehicle control system 6. The vehicle control system 6 includes a vehicle control ECU 60, an accelerator position sensor 61, a brake stepping-on force sensor 62, a steering angle sensor 63, a steering torque sensor 64, a vehicle speed sensor 65, an electronically controlled throttle 66, a brake actuator 67, and an EPS motor 68.

The accelerator position sensor 61 detects an amount of the stepping-on of the accelerator pedal by the driver, and outputs it to the vehicle control ECU 60. The brake stepping-on force sensor 62 detects an amount of the stepping-on of the brake pedal by the driver, and outputs it to the vehicle control ECU 60. The steering angle sensor 63 detects, as a rudder angle, a steering angle or a turning angle. The steering torque sensor 64 detects a steering torque applied by the driver to the steering wheel, and outputs it to the vehicle control ECU 60. The vehicle speed sensor 65 measures a rotation speed of the output axis of the transmission or the axle, thereby detecting a current travel speed of the host vehicle and outputting it to the vehicle control ECU 60.

The electronically controlled throttle 66 controls an opening degree of the throttle based on the control signal outputted from the vehicle control ECU 60. The brake actuator 67 controls a braking force that is generated in each wheel due to an occurrence of a braking pressure based on the control signal outputted from the vehicle control ECU 60. The EPS motor 68 controls a force to steer and a force to hold steering which are applied to the steering mechanism based on the control signal outputted from the vehicle control ECU 60.

The vehicle control ECU 60 is an electronic control unit which performs acceleration and deceleration control and/or steering control of the host vehicle. The vehicle control ECU 60 includes a steering ECU which performs steering control, a power unit control ECU which performs acceleration and deceleration control, and a brake ECU. The vehicle control ECU 60 acquires detection signals from a sensor mounted in the host vehicle such as the accelerator position sensor 61, the brake stepping-on force sensor 62, the steering angle sensor 63, or the vehicle speed sensor 65, and outputs a control signal to travel control devices such as the electronically controlled throttle 66, the brake actuator 67, and the EPS motor 68. The vehicle control ECU 60 performs an acceleration and deceleration control and/or a steering control of the host vehicle in compliance with the instructions from the driving assistance ECU 9 at the time of executing a driving assistance application. In addition, the vehicle control ECU 60 outputs detection signals from the above respective sensors 61 to 65, to the in-vehicle LAN 10.

<Schematic Configuration of Driving Assistance ECU 9>

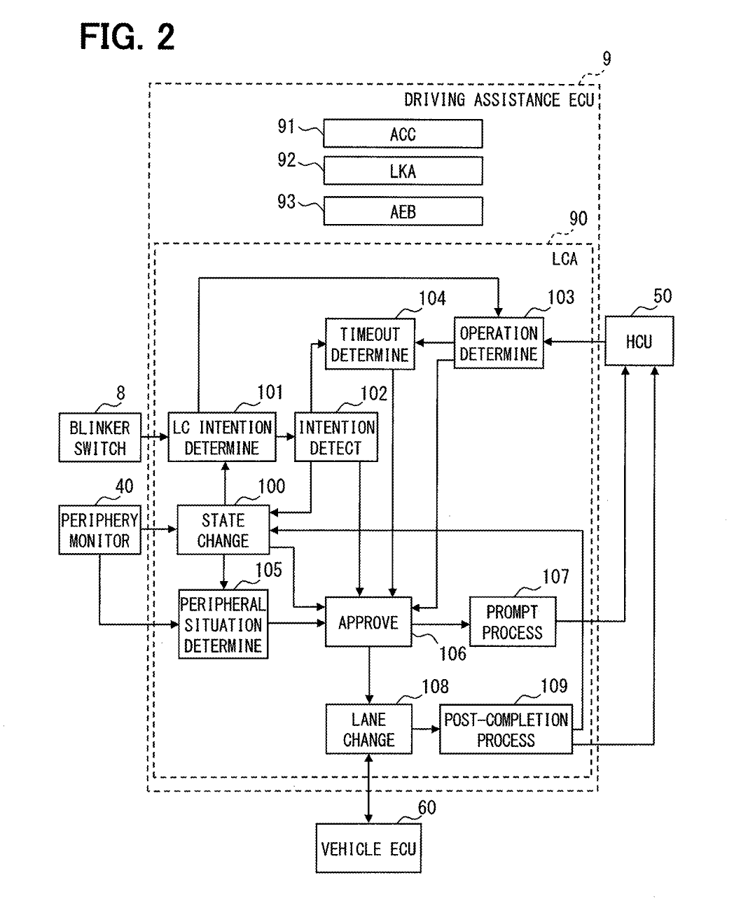

The following explains a schematic configuration of the driving assistance ECU 9 with reference to FIG. 2. The driving assistance ECU 9 executes a control program stored in a nonvolatile memory, thereby configuring an LCA (Lane Change Assist) function part 90, an ACC (Adaptive Cruise Control) function part 91, an LKA (Lane Keeping Assist) function part 92, and an AEB (Autonomous Emergency Braking) function part 93, as functional blocks. Such functional blocks implement the driving assistance applications mentioned above.

The ACC function part 91 causes the vehicle control ECU 60 to adjust the driving force and the braking force based on the monitoring information of a preceding vehicle acquired from the periphery monitoring ECU 40, thereby achieving the function of ACC that controls the travel speed of the host vehicle. When any preceding vehicle is not detected, the ACC function part 91 makes the host vehicle travel with a constant speed of a target travel speed set by the driver via the manipulation device 58. In contrast, when a preceding vehicle is detected, the ACC function part 91 sets the speed of the preceding vehicle as a target travel speed while setting a target inter-vehicle distance up to the preceding vehicle according to the target travel speed. The ACC function part 91 then causes the host vehicle to perform a tracking travel to follow the preceding vehicle while controlling the acceleration and deceleration to match with the target inter-vehicle distance. The speed of the preceding vehicle may be obtained from (i) the relative speed of the preceding vehicle with the host vehicle detected by the periphery monitoring ECU 40, and (ii) the vehicle speed of the host vehicle obtained from the signal of the vehicle speed sensor 65 of the host vehicle.

The LKA function part 92 causes the vehicle control ECU 60 to adjust the steering force, thereby achieving the function of LKA which controls the rudder angle of the steering wheel of the host vehicle. The LKA function part 92 allows the generation of the steering force to the direction so as to prevent a close approach to the lane dividing marking line, thereby maintaining the host vehicle within the current lane the host vehicle is currently running. Hereinafter, a within-lane driving assistance is defined as a driving assistance which achieves an automated driving within a current lane the host vehicle is currently running by both the function of ACC and the function of LKA cooperating with each other.

The AEB function part 93 causes the vehicle control ECU 60 to adjust a braking force based on the monitoring information ahead of the host vehicle acquired from the periphery monitoring ECU 40, thereby achieving the function of collision damage alleviation braking (i.e., AEB) to perform an automatic deceleration of the vehicle speed of the host vehicle compulsorily. As a specific example, automatic deceleration of the vehicle speed of the host vehicle is made compulsorily when an emergency control condition is satisfied by TTC (time to collision) to an object ahead of the host vehicle becoming less than a set value, e.g., five seconds.

The LCA function part 90 achieves the function of LCA which moves the host vehicle to an adjacent lane from the current lane the host vehicle is currently running. The details of the LCA function part 90 will be explained later.

Further, the driving assistance ECU 9 may be configured to achieve the function of another driving assistance such as the function of BSM (Blind Spot Monitor), which reports presence of a different vehicle in a rear and left area and a rear and right area relative to the host vehicle to the driver, based on the monitoring information in a rear and left area and a rear and right area relative to the host vehicle acquired from the periphery monitoring ECU 40.

<Schematic Configuration of LCA Function Part 90>

The following explains a schematic configuration of the LCA function part 90 with reference to FIG. 2. The LCA function part 90 includes, as functional blocks, a state changer section 100, an LC (Lane Change) intention determiner section 101, an intention detector section 102, an operation determiner section 103, a timeout determiner section 104, a peripheral situation determiner section 105, an approver section 106, a prompt processor section 107, a lane changer section 108, and a post-completion processor section 109 (which may be also referred to as a state changer 100, an LC (Lane Change) intention determiner 101, an intention detector 102, an operation determiner 103, a timeout determiner 104, a peripheral situation determiner 105, an approver 106, a prompt processor 107, a lane changer 108, and a post-completion processor 109).

The state changer section 100 changes the state of the LCA function of the host vehicle. The state changer section 100 changes the state to LC_OFF that disables the function of LCA when the within-lane driving assistance is turned OFF (i.e., both the functions of ACC and LKA are disabled to operate), for example. Further, the state is changed to LC_OFF when any adjacent lane of the host vehicle cannot be detected by the periphery monitoring ECU 40. The case of failing to detect an adjacent lane of the host vehicle corresponds to the case of failing to detect a lane dividing marking line between the current lane and an adjacent lane. In contrast, when the within-lane travel assistance is turned ON (i.e., both the functions of ACC and LKA are operated), and, simultaneously, the adjacent lane of the host vehicle is detected by the periphery monitoring ECU 40, the state changer section 100 changes the state of the LCA function part 90 to LC_READY which is the state ready for executing the function of LCA.

In addition, the state changer section 100 changes the state of the LCA function part 90 to LC_ON which executes the LCA function, when the LC intention determiner section 101 determines that the driver expresses an intention of the lane change, which will be explained later. In contrast, the state changer section 100 changes the state to LC_READY when the timeout determiner section 104 determines that the determination result of the LC intention determiner section 101 or the operation determiner section 103 is invalid, which will be explained later. Furthermore, the state changer section 100 changes the state to LC_READY when the steering in the lane changer section 108 is completed, which will be explained later.

The LC intention determiner section 101 determines the intention of the lane change of the driver, when the state is in LC_READY. As an example, it is determined that the driver expresses the intention of the lane change (hereinafter, referred to as expression of LC intention), when the blinker signal at the time of the right/left turn is acquired from the blinker switch 8. When the blinker signal at the time of the right-turn is acquired, it may be determined that the expression of LC intention to the right adjacent lane is made. When the blinker signal at the time of the left-turn is acquired, it may be determined that the expression of LC intention to the left adjacent lane is made. When any blinker signal at the time of the left-turn or the right-turn is not acquired, it may be determined that any expression of LC intention is not made. In the first embodiment, this blinker lever 7 is equivalent to a manipulation member.

The intention detector section 102 starts the count from the starting point of time that is a point of time when the LC intention determiner section 101 determines that the expression of LC intention is made. That is, the count is started from the point of time when the blinker lever 7 is manipulated. The event that the count reaches a specified value is detected as an event that the driver approves a lane change (hereinafter, referred to as a steering start trigger being turned ON). The count may be the count of an elapsed time or the count of a travel distance of the host vehicle. The following explains an example of the count of an elapsed time. The count of an elapsed time may be made using a timer circuit. The count is equivalent to a measurement value.

The operation determiner section 103 determines whether the driver executes a safety confirming operation needed when a lane change is to be performed, based on the detection result of the DSM 51 successively outputted from the HCU 50. The determination by the operation determiner section 103 may be desirably started after the LC intention determiner section 101 determines that the expression of LC intention is made. This is because the processing load of the driving assistance ECU 9 can be reduced as compared with a configuration where the operation determiner section 103 performs the determination always.

The following explains an example of the determination performed by the operation determiner section 103 when the LC intention determiner section 101 determines that the expression of LC intention to the right adjacent lane is made. The operation determiner section 103 may determine that the driver executes a safety confirming operation in the following case: the face direction and/or the sight line direction of the driver detected by the DSM 51 first moves from a front area to a rear and right area relative to the host vehicle, remains in a state of being directed to the rear and right area equal to or greater than a predetermined period of time, and then turns to the front area relative to the host vehicle. Such a predetermined period of time is defined as a period of time assumed to be required for executing a safety confirming operation and variable as needed.

In addition, in cases that the DSM 51 detects the sight line direction of the driver, the safety confirming operation may be determined to have been executed when the sight line direction moves, in sequence, to the front area relative to the host vehicle, the right door mirror, the rear and right area relative to the host vehicle, and the front area. With respect to the right door mirror and the rear and right area, a condition may be additionally required; the condition is satisfied when the sight line directed to each of the right door mirror and the rear and right area remains more than a predetermined period of time,

Note that the determination performed by the operation determiner section 103 when the LC intention determiner section 101 determines that the expression of LC intention to the left adjacent lane is made is the same as that when determining that the expression of LC intention to the right adjacent lane is made, except for right and left being reversed.

The timeout determiner section 104 determines whether the detection result of the intention detector section 102 and the determination result of the operation determiner section 103 each pass a valid duration (i.e., to be timed out). The detection result of the intention detector section 102 is determined to be timed out when an elapsed time since the intention detector section 102 detects the steering start trigger being turned ON is equal to or greater than a first valid period of time. It is determined to be valid when being less than the first valid period of time. Such a first valid period of time may be set as needed, for instance, several seconds.

The determination result by the operation determiner section 103 is determined to be timed out when the elapsed time since the operation determiner section 103 determines that the safety confirming operation is executed is equal to or greater than a second valid period of time. It is determined to be valid when being less than the second valid period of time. The second valid period of time may be a period of time for which the state in a rear and lateral area in an adjacent lane is supposed to be varied and may be set as needed. For example, the second valid period of time may be several seconds.

When the state changes to LC_ON state, the peripheral situation determiner section 105 determines successively whether the peripheral situation of the host vehicle is a situation where the host vehicle can perform a lane change to an adjacent lane based on the monitoring information successively outputted from the periphery monitoring ECU 40. As one example, it is determined that the peripheral situation of the host vehicle is a situation enabling a lane change where the host vehicle can perform a lane change to an adjacent lane when there is no object approaching the host vehicle in a rear and lateral area relative to the host vehicle in the lane to which the lane change is going to be made, based on the monitoring information on a rear and lateral area relative to the host vehicle which the milliwave radar 42 detects. In contrast, it is determined that the peripheral situation is a situation disabling a lane change where the host vehicle cannot perform a lane change when there is an object approaching the host vehicle in a rear and lateral area in the lane to which the lane change is going to be made.

Further, the peripheral situation determiner section 105 may determine whether there is a different vehicle approaching the host vehicle in a rear and lateral area in the lane to which the lane change is going to be made based on the position information and the travel speed information of a peripheral vehicle which is acquired from the ITS communicator 3, thereby determining whether or not the peripheral situation is a situation enabling a lane change where the host vehicle can perform a lane change.

The approver section 106 may be also referred to as a change approver section or a change approver. When the state changes to LC_ON state, the approver section 106 approves the lane change of the host vehicle or does not approve based on whether a predetermined condition is satisfied or not. Such a predetermined condition is satisfied when: the steering start trigger being turned ON is detected by the intention detector section 102; it is determined that the safety confirming operation is executed by the operation determiner section 103; it is determined that the peripheral situation is a situation where the lane change is enabled by the peripheral situation determiner section 105; and it is not determined that the determination results of the LC intention determiner section 101 and the operation determiner section 103 are timed out by the timeout determiner section 104. In the above, the specified value is equivalent to a period of time less than the first valid period of time and set as needed, for instance, three seconds.

The prompt processor section 107 outputs an instruction, which prompts the driver to execute a safety confirming operation, to the HCU 50, based on that it is determined that the safety confirming operation is executed by the operation determiner section 103. As one example, a configuration to prompt the driver to execute a safety confirming operation may be provided when the operation determiner section 103 determines that any safety confirming operation is not executed although the intention detector section 102 has detected the steering start trigger being turned ON. Note that in order not to perform a notice uselessly to a driver responding regularly slow such as an elderly person, such a notice may be performed under a condition a predetermined time elapses since the steering start trigger being turned ON is detected by the intention detector section 102. Such a predetermined time may be set as needed in considering a period of time for which a driver responding regularly slow such as an elderly person can complete a safety confirming operation.

The HCU 50, which receives the instruction, causes the display device or the audio speaker 57 to perform a notice which prompts the driver to execute a safety confirming operation. As one example, a configuration may be provided where the display device such as the electron mirror 56 performs a display which prompts the driver to execute a safety confirming operation, or where only a lamp such as an LED is turned ON.

The lane changer section 108 provides an instruction to the vehicle control ECU 60 to generate the steering force directing the host vehicle to an adjacent lane, thereby moving the host vehicle into the adjacent lane. When the steering in the process by the lane changer section 108 moving the host vehicle into the adjacent lane is completed, the post-completion processor section 109 performs a process after the steering is completed.

As one example of a process after the steering is completed, a configuration may be provided where an instruction is provided to the HCU 50 to perform a notice which indicates that the lane change is completed, causing the display device or the audio speaker 57 to perform a notice which indicates that the lane change is completed. Suppose a configuration which performs a display indicating such a lane change in progress, during a lane change. In such a configuration, the display indicating the lane change in progress may be finished due to the process after the steering is completed. As another example, a configuration may be provided which provides an instruction to an electronic control unit operating the blinker lever to thereby automatically return the blinker lever 7 operated by the driver into the neutral position.

<LCA Related Process>

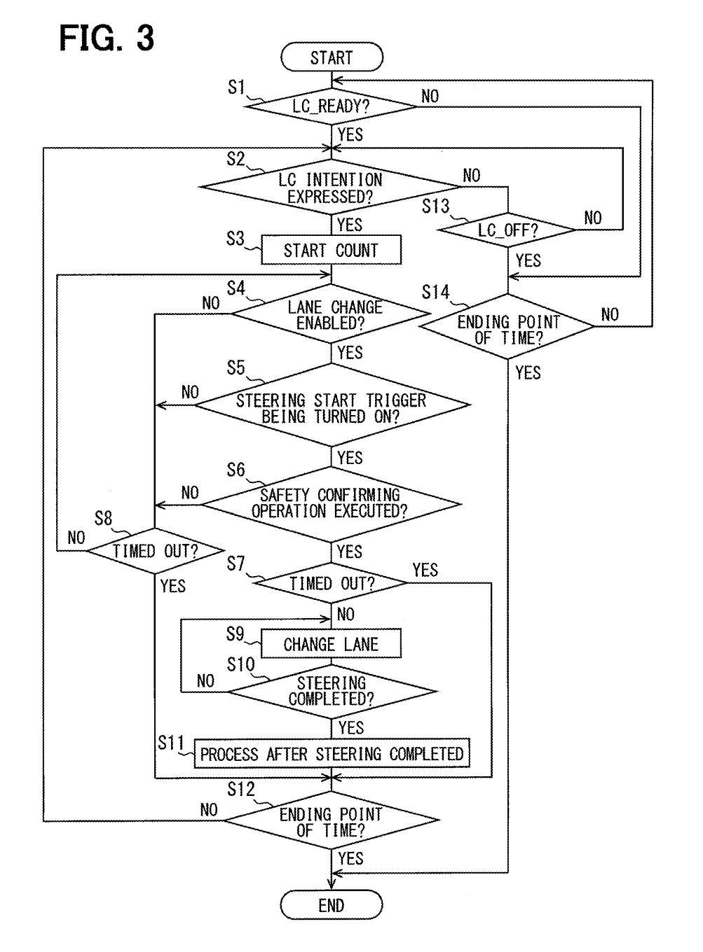

The following explains an example of a sequence of a process (hereinafter, referred to as an LCA related process) that is relative to the function of LCA by the driving assistance ECU 9 with reference to a flowchart of FIG. 3. The flowchart of FIG. 3 may be started when a within-lane driving assistance that is a driving assistance within a lane by the driving assistance ECU 9 is turned ON (i.e., both the functions of ACC and LKA operating).

It is further noted that a flowchart to be described includes sections (also referred to as steps), which are represented, for instance, as S1. Further, each section can be divided into several sections while several sections can be combined into a single section. Each section may be referred to as a device or a specific name, or with a structure modification; for instance, an operation determiner section may be also referred to as an operation determiner device or an operation determiner. Further, each section can be achieved not only (i) as a software section in combination with a hardware unit (e.g., computer), but also (ii) as a section of a hardware circuit (e.g., integrated circuit, hard wired logic circuit), including or not including a function of a related apparatus. Further, the section of the hardware circuit may be inside of a microcomputer.

First, at Si, when the state of the LCA function part 90 is changed into LC_READY by the state changer section 100 (S1: YES), the sequence proceeds to S2. In contrast, when being in LC_OFF instead of LC_READY (Si: NO), the sequence proceeds to S14.

At S2, when it is determined by the LC intention determiner section 101 that the expression of LC intention is made (S2: YES), the sequence proceeds to S3. In contrast, when it is determined that the expression of LC intention is not made (S2: NO), the sequence proceeds to S13. At S3, the intention detector section 102 starts the count at the start time that is a point of time when the LC intention determiner section 101 determines that the expression of LC intention is made.

At S4, when the peripheral situation determiner section 105 determines that the peripheral situation is a situation where the lane change is enabled (S4: YES), the sequence proceeds to S5. In contrast, when the peripheral situation determiner section 105 determines that the peripheral situation is a situation where the lane change is disabled (S4: NO), the sequence proceeds to S8.

At S5, when the count by the intention detector section 102 reaches a specified value and the intention detector section 102 detects the steering start trigger being turned ON (S5: YES), the sequence proceeds to S6. In contrast, when the steering start trigger being turned ON is not detected by the intention detector section 102 (S5: NO), the sequence proceeds to S8.

At S6, when the operation determiner section 103 determines that a safety confirming operation is executed (S6: YES), the sequence proceeds to S7. In contrast, when the operation determiner section 103 determines that a safety confirming operation is not executed (S6: NO), the sequence proceeds to S8,

At S7, when the timeout determiner section 104 determines that the determination result of either the LC intention determiner section 101 or the operation determiner section 103 is timed out (S7: YES), the sequence proceeds to S12. In contrast, when the timeout determiner section 104 determines that the determination result of each of the LC intention determiner section 101 and the operation determiner section 103 is valid (S7: NO), the approver section 106 approves the lane change of the host vehicle; then, the sequence proceeds to S9.

Further, at S8, when the timeout determiner section 104 determines that the determination result of either the LC intention determiner section 101 or the operation determiner section 103 is timed out (S8: YES), the sequence proceeds to S12. In contrast, when the timeout determiner section 104 determines that the determination result of each of the LC intention determiner section 101 and the operation determiner section 103 is valid (S8: NO), the sequence returns to S4 to repeat the process.

When it is determined to be timed out at S7 or S8, an instruction of providing a notice indicating that a repeated manipulation of the blinker lever 7 and a safety confirming operation are necessary may be preferably outputted to the HCU 50, thereby performing the notice via the display device or the audio speaker 57. Further, when it is determined to be timed out at S7 or S8, another configuration may be provided which returns automatically the blinker lever 7 manipulated by the driver to the neutral position, thereby causing the driver to recognize that a repeated manipulation of the blinker lever 7 and a safely confirming operation are necessary.

At S9, the lane changer section 108 provides an instruction to the vehicle control ECU 60, moving the host vehicle to an adjacent lane. At S10, when the steering by the lane changer section 108 is completed (S10: YES), the sequence proceeds to S11. In contrast, when the steering by the lane changer section 108 is not completed (S10: NO), the sequence returns to S9 to repeat the process. At S11, the post-completion processor section 109 performs the process after the steering is completed; then, the sequence proceeds to S12.

At S12, when the LCA related process arrives at a point of time of ending (S12: YES), the LCA related process is ended. In contrast, when the LCA related process does not arrive at a point of time of ending (S12: NO), the sequence returns to S2 to repeat the process. One example of the point of time of ending of the LCA related process includes the within-lane driving assistance being turned OFF due to the driver manipulating the manipulation device 58, or the ignition power source of the host vehicle being turned into OFF state.

At S13 performed when it is determined that the expression of LC_intention is not made at 82, when the LCA function part 90 is in the state of LC_OFF (S13: YES), the sequence proceeds to S14. In contrast, when the LCA function part 90 is not in the state of LC_OFF (S13: NO), the sequence returns to S2 to repeat the process.

In addition, at S14 performed when the LCA function part 90 is not in the state of LC_READY at S1, when the LCA related process arrives at a point of time of ending (S14: YES), the LCA related process is ended. In contrast, when the LCA related process does not arrive at a point of time of ending (S14: NO), the sequence returns to S1 to repeat the process.

<State Change of LCA Function Part 90>

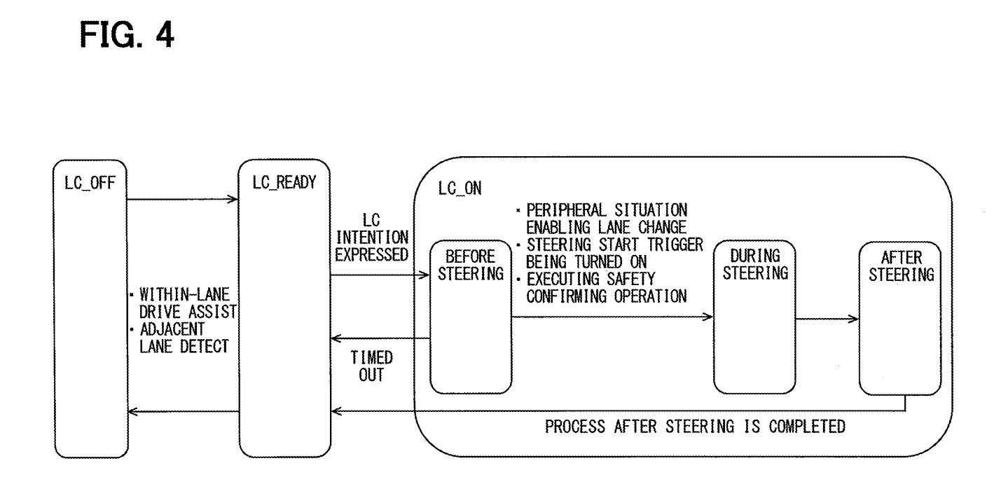

The state change of the LCA function part 90 is summarized with reference to FIG. 4. As explained above, the LCA function part 90 is in the state of LC_OFF at least either (i) when the within-lane driving assistance is turned OFF, or (ii) when the adjacent lane of the host vehicle is not detected by the periphery monitoring ECU 40. In contrast, the LCA function part 90 changes from the state of LC_OFF into the state of LC_READY, when, under the state of LC_OFF, the within-lane driving assistance is turned ON and, simultaneously, the adjacent lane of the host vehicle is detected by the periphery monitoring ECU 40.

In addition, when the LC intention determiner section 101 determines that the expression of the driver lane change intention is made under the state of LC_READY, the LCA function part 90 changes into the state of LC_ON. When the timeout determiner section 104 determines that it is timed out under the state of LC_ON, the LCA function part 90 changes into the state of LC_READY. In contrast, without the determination that it is timed out under the state of LC_ON, the following three conditions are satisfied simultaneously, the lane change is allowed to start the steering. The three conditions are (i) the peripheral situation where the lane change is enabled; (ii) the steering start trigger being turned ON being detected; and (iii) the safety confirming operation being executed. When the steering is completed, the process after the steering is completed is executed, and the lane change is thus completed, the LCA function part 90 changes from the state of LC_ON into the state of LC_READY.

### Summary of First Embodiment

The first embodiment provides configurations as follows. When the operation determiner section 103 determines that the driver does not execute a safety confirming operation needed when a lane change is to be performed, the approver section 106 does not approve an automated lane change by the lane changer section 108. Therefore, even in cases that the case where the LCA function performs an automated lane change of a vehicle, the driver is required to execute a safety confirming process at a lane change. In addition, the lane change is disabled unless the driver executes a safety confirming operation at a lane change; the driver can be prompted to execute a safety confirming operation. This enables the driver to become accustomed to a safety confirming operation needed when the lane change is to be performed, prompting the driver to grow.

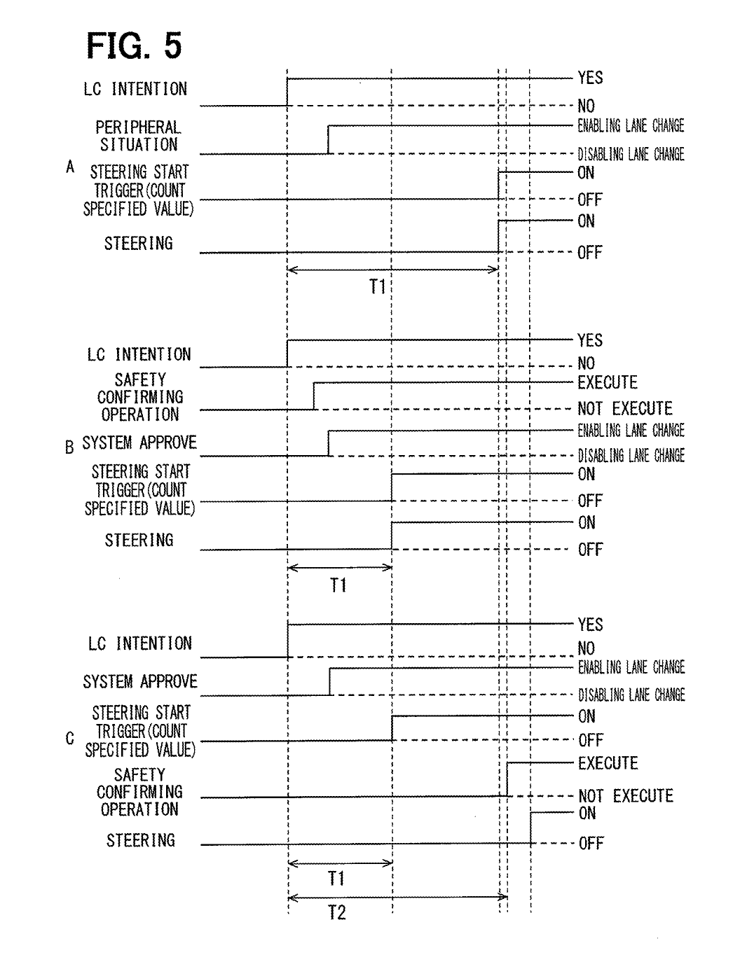

In addition, under the configuration turning ON of the steering start trigger based on that the count since the expression of LC intention is determined by the LC intention determiner section 101 has reached a specified value, the execution of a safety confirming operation by the driver is an indispensable condition for the lane change approval. This enables the point of time of starting the steering at the lane change to be applied to each of persons. The following explains in detail with reference to FIG. 5.

In FIG. 5, “A” indicates an example case where the execution of a safety confirming operation by a driver is not an indispensable condition for a lane change approval. In FIG. 5, “B” and “C” each indicate an example case where the execution of a safety confirming operation by a driver is an indispensable condition for a lane change approval. Further, in FIG. 5, “B” indicates an example of a driver promptly responding from manipulating the blinker lever 7 to executing a safety confirming operation; in FIG. 5, “C” indicates an example of a driver slowly responding from manipulating the blinker lever 7 to executing a safety confirming operation.

Suppose the case where the execution of a safety confirming operation by a driver is not an indispensable condition for a lane change approval, like in “A” in FIG. 5. In this case, in considering a driver slowly executing a safety confirming operation, the specified value (refer to “T1” in “A”) for turning the steering start trigger ON needs to be set to be greater.

In contrast, in the configuration of the first embodiment, the execution of a safety confirming operation by a driver is an indispensable condition for a lane change approval. Thus, without considering a driver slowly executing a safety confirming operation, the specified value (refer to “T1” in “B” “C”) for turning the steering start trigger ON is allowed to be set to be less than that in “A”. If a driver promptly responds from manipulating the blinker lever 7 to executing a safety confirming operation, the steering is enabled to be started earlier than in “A” by a part obtained by setting the specified value of the count to be less (refer to “T1” in “B”). In contrast, if a driver slowly responds from manipulating the blinker lever 7 to executing a safety confirming operation, the steering is not started until the safety confirming operation is executed even though the count reaches the specified value (refer to “T2” in “C”). The first embodiment thus enables the point of time of starting the steering at the lane change to be applied to each of persons.

### Second Embodiment

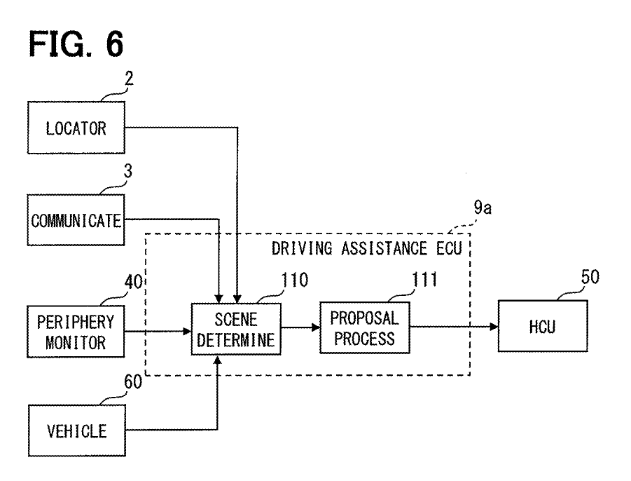

Another configuration (hereinafter, a second embodiment) may be provided which determines whether a current driving scene is desirable for a lane change before the LC intention determiner section 101 determines whether the expression of LC intention is made, and then proposes the lane change to the driver. The following explains an example of a schematic configuration of a driving assistance ECU 9a according to the second embodiment with reference to FIG. 6. In FIG. 6, among the constituent elements of the driving assistance ECU 9a, other than those different from the driving assistance ECU 9 are omitted for convenience. The driving assistance ECU 9a is the same as the driving assistance ECU 9 in the first embodiment, except for including a scene determiner section 110 and a proposal processor section 111 (which may be also referred to as a scene determiner 110 and a proposal processor 111). The scene determiner section 110 and the proposal processor section 111 may be configured to be included or not included in the LCA function part 90.

The scene determiner section 110 determines whether a driving scene takes place which is desirable for a lane change based on the travel state of the host vehicle and/or the situation of the periphery of the host vehicle.

For example, the scene determiner section 110 determines whether a driving scene takes place which is desirable for a lane change based on (i) the position of the host vehicle and the position of an intersection which are obtained from the ADAS locator 2, and (ii) the inter-vehicle distance between the host vehicle and the preceding vehicle which is obtained from the periphery monitoring ECU 40. As a specific example, a driving scene which is desirable for a lane change may be determined to take place when (i) the host vehicle is separated from an intersection a predetermined distance or more and, simultaneously, (ii) the inter-vehicle distance between the host vehicle and the preceding vehicle is equal to or less than a predetermined value.

The above predetermined distance may be set as needed to be at least equal to or greater than a distance prohibiting a lane change before an intersection. In contrast, the above predetermined value may be set as needed to be a target inter-vehicle distance under the case where the preceding vehicle runs with a speed significantly lower than a regulation limiting speed. Further, the predetermined value may be changed as needed according to a regulation limiting speed contained in the map data acquired from the ADAS locator 2, or a fixed constant value regardless of the regulation limiting speed.

In addition, the scene determiner section 110 determines whether a driving scene takes place which is desirable for a lane change of the host vehicle based on the position of the host vehicle and lane regulation information which are acquired from the ADAS locator 2. As a specific example, it may be determined that a driving scene takes place which is desirable for a lane change when the host vehicle approaches a position distant by a predetermined distance from a spot at which the host vehicle needs to perform the lane change due to the lane regulation. The predetermined distance may be set as needed.

A configuration may be provided which acquires the lane regulation information on the spot at which the lane change is needed due to the lane regulation from a roadside unit via the ITS communicator 3. Further, another configuration may be provided which acquires the lane regulation information by detecting a sign or a signboard indicating the lane regulation information from a captured image by the periphery monitoring camera 41 using an image recognition process.

Further, yet another configuration may be provided where the driving assistance ECU 9 can obtain the information on a scheduled route that the host vehicle is scheduled to travel, such as a recommended route during route guidance by a car navigation apparatus or a scheduled route due to an automated driving. In such a case, the scene determiner section 110 may determine whether a driving scene takes place which is desirable for a lane change by using the scheduled route. For instance, the scene determiner section 110 may determine the driving scene takes place which is desirable for a lane change when the scheduled route indicates that the host vehicle needs a right/left turn at an intersection in the heading direction and a lane change is necessary for the right/left turn.

The proposal processor section 111 outputs an instruction, which requires a notice proposing a lane change of the host vehicle, to the HCU 50, when the scene determiner section 110 determines that a driving scene, which is desirable for a lane change, takes place. The HCU 50, which receives the instruction requiring the notice, performs the notice proposing a lane change of the host vehicle via the display device or the audio speaker 57. One example configuration of the notice may be provided which performs the display of the text and icon which propose the lane change in the display device such as the electron mirror 56.

The configuration in the second embodiment provides an advantageous effect to relieve the driver from determining the point of time at which a lane change is desirable to be made.

### FIRST MODIFICATION EXAMPLE

The first embodiment and the second embodiment each provide the configuration which starts the determination by the operation determiner section 103 after the LC intention determiner section 101 determines that the expression of LC intention is made; however, there is no need to be limited thereto. For example, another configuration (hereinafter, a first modification example) which starts the determination by the operation determiner section 103 before the LC intention determiner section 101 determines that the expression of LC intention is made.

As one example, a configuration may be provided where the determination by the operation determiner section 103 is started when the LCA function part 90 changes into the state of LC_READY from any other state. Further, another configuration may be provided, by combining with the configuration in the second embodiment, where the determination by the operation determiner section 103 is started after the notice by the proposal processor 111 is made which proposes the lane change of the host vehicle.

Note that providing the configuration in the first modification example enables the point of time at which the safety confirming operation is determined to be executed to be earlier than that in the first embodiment. The second valid period of time used by the timeout determiner section 104 may be thus longer than that in the first embodiment.

The first modification example provides the configuration which starts the determination by the operation determiner section 103 before the expression of LC intention is determined to be made by the LC intention determiner section 101. This enables the determination target for a safety confirming operation at a lane change to include a safety confirming operation executed by the driver before the manipulation of the blinker lever 7. This can further prevent an occurrence of a situation disapproving a lane change upon mistakenly assuming that any safety confirming operation is not executed, although the safety confirming operation has been executed before the manipulation of the blinker lever 7.

Note that even the configuration according to the first modification example is provided to disapprove a lane change unless a safety confirming operation is executed. This prevents the steering for the lane change from starting with only a condition of an elapsed time since the manipulation of the blinker lever 7. This further prevents a failure starting automatically the steering for a lane change before the driver completes a safety confirming operation that is started after the manipulation of the blinker lever 7 is made.

### SECOND MODIFICATION EXAMPLE

The first embodiment and the second embodiment each provide the configuration which starts the LCA related process when the within-lane driving assistance is turned ON; however, there is no need to be limited thereto. For example, another configuration may be provided which starts also when the function of ACC is operated without the function of LKA is operated, or which starts when the vehicle is manually driven with neither the function of ACC nor the function of LKA operated.

### THIRD MODIFICATION EXAMPLE

The first embodiment and the second embodiment each define the followings as the condition for approving a lane change: the intention detector section 102 detects the steering start trigger being turned ON; the operation determiner section 103 determines that the safety confirming operation is executed; the peripheral situation determiner section 105 determines that the peripheral situation takes place which enables a lane change; and the timeout determiner section 104 does not determine that it is timed out. However, there is no need to be limited thereto.

For example, another configuration may be provided where the steering start trigger being turned ON being detected by the intention detector section 102 is excluded from the condition for approving a lane change. Further, another configuration may be provided where the peripheral situation being determined to enable a lane change by the peripheral situation determiner section 105 is excluded from the condition for approving a lane change. In addition, another configuration may be provided where that the timeout determiner section 104 does not determine that it is timed out is excluded from the condition for approving a lane change.

### FOURTH MODIFICATION EXAMPLE

The first embodiment and the second embodiment provides the configuration where the intention detector section 102 detects the steering start trigger being turned ON when the count, which is started at a time when the LC intention determiner section 101 determines that the expression of LC intention is made, reaches the specified value. However, there is no need to be limited thereto.

For example, another configuration may be provided which detects the steering start trigger being turned ON when the driver manipulates a button used to convey an intention of a lane change among the manipulation devices 58. In such a case, the manipulation device 58 is equivalent to a manipulation member. Further, another configuration may be provided which detects the steering start trigger being turned ON when the driver manipulates the steering wheel. In such a case, the steering wheel is equivalent to a manipulation member. In addition, manipulating the steering wheel by the driver may be detected by the intention detector section 102 from a signal outputted by the steering torque sensor 64.

### FIFTH MODIFICATION EXAMPLE

The first embodiment and the second embodiment each provide the configuration where the timeout determiner section 104 determines that it is timed out when the elapsed time since the intention detector section 102 detects the steering start trigger being turned ON is equal to or greater than a first valid period of time. However, there is no need to be limited thereto. For instance, another configuration may be provided which determines that it is timed out when an elapsed time since the driver manipulates the blinker lever 7 (i.e., the count by the intention detector section 102) is equal to or greater than the first valid period of time.

In this case, the first valid period of time may be set to be longer than a period of time during which the driver manipulates the blinker lever 7 and then completes a safety confirming operation. More desirably, in order not to determine that it is timed out during the execution of a safety confirming operation by a driver slowly executing the safety confirming operation, the first valid period of time may be set to be longer on the basis of the driver slowly executing a safety confirming operation. For example, the first valid period of time may be about ten seconds.

### SIXTH MODIFICATION EXAMPLE

In addition, a point of time at which the operation determiner section 103 determines whether a safety confirming operation is executed needs not be limited to the point of time explained in the first embodiment, and the first modification example.

### SEVENTH MODIFICATION EXAMPLE

The first embodiment and the second embodiment each provide the configuration where the prompt processor section 107 performs a notice prompting the driver to execute a safety confirming operation based on that the operation determiner section 103 determines that a safety confirming operation is not executed. However, there is no need to be limited thereto. For example, another configuration may be provided which performs a notice prompting the driver to execute a safety confirming operation before the operation determiner section 103 starts the determination of the safety confirming operation,

While the present disclosure has been described with reference to embodiments thereof, it is to be understood that the disclosure is not limited to the embodiments and constructions. The present disclosure is intended to cover various modification examples and equivalent arrangements. In addition, the various combinations and configurations, and other combinations and configurations, including more, less or only a single element, are also within the spirit and scope of the present disclosure.

1. A driving assistance apparatus provided with a lane changer section used in a vehicle to execute an automated lane change of the vehicle, the driving assistance apparatus comprising:
an operation determiner section configured to determine whether a driver of the vehicle executes a safety confirming operation at a lane change based on information from a sensor used to detect a state of the driver;
a change approver section configured to approve an automated lane change by the lane changer section; and section,
an intention detector section configured to detect that the driver approves a lane change of the vehicle based on a manipulation input by the driver to a predetermined manipulation member in the vehicle,
wherein:
the operation determiner section starts determining whether the safety confirming operation is executed before the intention detector section detects that the driver approves a lane change of the vehicle; and
the change approver section disapproves the automated lane change by the lane changer section when the operation determiner section determines that the driver fails to execute a safety confirming operation at a lane change, while
the change approver section disapproves the automated lane change by the lane changer section when the intention detector section fails to detect that the driver approves a lane change of the vehicle.

2. (canceled)

3. The driving assistance apparatus according to claim 1, wherein:
the intention detector section detects that the driver approves a lane change of the vehicle when a measurement value reaches a specified value, the measurement value being obtained by measuring either an elapsed time or a travel distance of the vehicle since the driver performs a manipulation input to the manipulation member; and
even in cases that the measurement value reaches the specified value, the change approver section disapproves the automated lane change by the lane changer section when the operation determiner section determines that the driver fails to execute a safety confirming operation at a lane change.

4. (canceled)

5. The driving assistance apparatus according to claim 1, further comprising:
a scene determiner section configured to determine whether a driving scene that is desirable for a lane change of the vehicle takes place; and
a proposal processor section configured to perform a notice which proposes a lane change of the vehicle when the scene determiner section determines that the driving scene that is desirable for a lane change of the vehicle takes place,
wherein
the operation determiner section determines whether the safety confirming operation is executed after the notice which proposes a lane change of the vehicle is performed by the proposal processor section.

6. The driving assistance apparatus according to claim 1, further comprising:
a prompt processor section configured to perform a notice which prompts the driver to execute the safety confirming operation.

7. The driving assistance apparatus according to claim 6, wherein
the prompt processor section performs the notice which prompts the driver to execute the safety confirming operation based on that the operation determiner section determines that the driver fails to execute the safety confirming operation.

8. The driving assistance apparatus according to claim 1, wherein
the operation determiner section determines whether the driver executes a safety confirming operation at a lane change from either a direction of a face of the driver or a direction of a sight line of the driver which is estimated successively from a capture image of a head of the driver captured successively by an image capture apparatus serving as the sensor.

9. A driving assistance apparatus provided with a lane changer section used in a vehicle to execute an automated lane change of the vehicle,
the driving assistance apparatus comprising:
an operation determiner section configured to determine whether a driver of the vehicle executes a safety confirming operation at a lane change based on information from a sensor used to detect a state of the driver;
a change approver section configured to approve an automated lane change by the lane changer section; and
a prompt processor section configured to perform a notice which prompts the driver to execute the safety confirming operation,
wherein:
the prompt processor section performs the notice which prompts the driver to execute the safety confirming operation before the operation determiner section determines whether the safety confirming operation is executed; and
the change approver section disapproves the automated lane change by the lane changer section when the operation determiner section determines that the driver fails to execute a safety confirming operation at a lane change.

10. The driving assistance apparatus according to claim 9, further comprising:
an intention detector section configured to detect that the driver approves a lane change of the vehicle based on a manipulation input by the driver to a predetermined manipulation member in the vehicle,
wherein
the change approver section disapproves the automated lane change by the lane changer section when the intention detector section fails to detect that the driver approves a lane change of the vehicle.

11. The driving assistance apparatus according to claim 10, wherein:
the intention detector section detects that the driver approves a lane change of the vehicle when a measurement value reaches a specified value, the measurement value being obtained by measuring either an elapsed time or a travel distance of the vehicle since the driver performs a manipulation input to the manipulation member; and
even in cases that the measurement value reaches the specified value, the change approver section disapproves the automated lane change by the lane changer section when the operation determiner section determines that the driver fails to execute a safety confirming operation at a lane change.

12. The driving assistance apparatus according to claim 11, wherein
the operation determiner section determines whether the safety confirming operation is executed after the driver performs the manipulation input to the manipulation member.

13. The driving assistance apparatus according to claim 9, further comprising:
a scene determiner section configured to determine whether a driving scene that is desirable for a lane change of the vehicle takes place; and
a proposal processor section configured to perform a notice which proposes a lane change of the vehicle when the scene determiner section determines that the driving scene that is desirable for a lane change of the vehicle takes place,
wherein
the operation determiner section determines whether the safety confirming operation is executed after the notice which proposes a lane change of the vehicle is performed by the proposal processor section.

14. The driving assistance apparatus according to claim 9, wherein
the prompt processor section performs the notice which prompts the driver to execute the safety confirming operation based on that the operation determiner section determines that the driver fails to execute the safety confirming operation.

15. The driving assistance apparatus according to claim 9, wherein
the operation determiner section determines whether the driver executes a safety confirming operation at a lane change from either a direction of a face of the driver or a direction of a sight line of the driver which is estimated successively from a capture image of a head of the driver captured successively by an image capture apparatus serving as the sensor.
